(19) United States
(12) Patent Application Publication
(10) Pub. No.: US 2010/0284772 A1
(43) Pub. Date: Nov. 11, 2010

(54) Vehicle lifting and maneuvering device

(76) Inventor: Mark William, Miami Garden, FL (US)

Correspondence Address: CONNORS ASSOCIATES, 1600 DOVE ST, SUITE 220, NEWPORT BEACH, CA, 92660, US

(21) Appl. No.: 12/716,334

(22) Filed: Mar. 3, 2010

Related U.S. Application Data
(63) Continuation of application No. 10/778,482, filed on Feb. 13, 2004.
Application No. 10/778,482 is a continuation-in-part of application No. 10/174,281, filed on Jul. 29, 2002, now abandoned.
(60) Provisional application No. 60/317,238, filed on Sep. 6, 2001.

(51) Int. Cl. B60P 1/02

(52) U.S. Cl. 414/495

(57) ABSTRACT

A vehicle lifting and maneuvering apparatus includes a rolling platform structure; a drive wheel mounted to and downwardly protruding from the platform structure; a direction control wheel pivotally mounted to and downwardly protruding from the platform structure; a drive motor mechanism drivably connected to the drive direction control wheels mechanism operationally linked to the for turning the direction control wheel; a steering power relative to the platform structure; a vehicle lifting structure and lifting structure drive mechanism secured relative to the platform structure and causing the lifting structure to one-of: advance upwardly relative to the platform structure and thereby bear against and lift a vehicle above the lifting structure, and advance downwardly and thereby lower relative to the platform structure; and a power source and a remote control mechanism connected to the drive motor mechanism and to the steering power mechanism and to the lifting structure drive mechanism.

### RELATED PATENT APPLICATIONS & INCORPORATION BY REFERENCE

This application is a continuation application of U.S. application Ser. No. 10/778,482, filed Feb. 13, 2004, entitled “VEHICLE LIFTING AND MANEUVERING DEVICE,” which is a continuation-in-part of application Ser. No. 10/174,281, filed on Jul. 29, 2002, which is a utility application that claims the benefit under 35 USC 119(e) of U.S. provisional application No. 60/317,238, filed on Sep. 6, 2001. All of these related applications are incorporated herein by reference and made a part of this application.

### BACKGROUND OF THE INVENTION

1. Field of the Invention

The present invention relates generally to the field of vehicle servicing equipment. More specifically the present invention relates to a vehicle lifting and maneuvering apparatus including a rolling platform structure having two downwardly protruding drive wheels interconnected by a drive axle mounted to the platform structure and two downwardly protruding direction control wheels pivotally mounted to the platform structure and interconnected by a steering linkage, a drive motor means drivably connected to the drive axle, a steering power means pivotally linked to the steering linkage for moving the steering linkages relative to the platform structure and thereby turning the direction control wheels, vehicle lifting structure and lifting structure drive means causing the lifting structure to one of: advance upwardly relative to the platform structure, and thereby bear against and lift a vehicle above the lifting structure, and advance downwardly and thereby lower the vehicle. A power source and a remote control mechanism are provided.

2. Description of the Prior Art

There have long been jacks for lifting and lowering vehicles, particularly automobiles and trucks. Some of these prior jacks have had wheels so that after one end of a vehicle has been lifted, the combination jack and vehicle can be rolled within a garage. A problem with these prior wheeled jacks has been that no convenient or remote operated way of steering the jack and vehicle has been provided.

One such prior jack is that of Ichinose, Japanese Patent number JP 361 036 045 A published on Feb. 20, 1986 for a car shifting machine. Ichinose includes a jack driven by a motor mounted on a machine body frame and operated by remote control. Billings, U.S. Pat. No. 6,182,577, issued on Feb. 6, 2001, discloses an automobile transport unit. The Billings unit includes several cable cars and pallets for transporting automobiles along a main highway.

Keaton, et al., U.S. Pat. No. 6,612,152, issued on Sep. 2, 2003, teaches an apparatus for lifting and servicing automobiles to diagnose repair needs.

Bienek, et al., U.S. Pat. No. 5,012,879, issued on May 7, 1991, reveals a self-propelled jacking apparatus for factory constructed buildings. Bienek, et al., includes unites used in pairs, each unit including two jacks, a jack plate pivoted on the active end of each jack, two wheels and an interconnecting support structure supporting each jack, adjustable length tie bars interconnecting the jack plates and the apparatus to drive and control the wheels.

It is thus an object of the present invention to provide a vehicle lifting and maneuvering device which is mounted on wheels is self powered, and which can lift at least one end of a vehicle so that the vehicle can be rolled, such as around a garage. It is another object of the present invention to provide such a device which is remotely controlled.

It is still another object of the present invention to provide such a device which includes remote control steering means, so that the device and vehicle can be both moved and maneuvered.

It is finally an object of the present invention to provide such a device which is sturdy, compact, reliable and relatively inexpensive to manufacture.

### SUMMARY OF THE INVENTION

The present invention accomplishes the above-stated objectives, as well as others, as may be determined by a fair reading and interpretation of the entire specification.

A vehicle lifting and maneuvering apparatus is provided, including a rolling platform structure; two drive wheels interconnected by a drive axle mounted to and downwardly protruding from the platform structure; two direction control wheels pivotally mounted to and downwardly protruding from the platform structure and interconnected by a steering linkage; a drive motor mechanism drivably connected to the drive axle; a steering power mechanism pivotally linked to the steering linkage for moving the steering linkage relative to the platform structure and thereby turning the direction control wheels relative to the platform structure; a vehicle lifting structure and lifting structure drive mechanism secured relative to the platform structure and causing the lifting structure to one of: advance upwardly relative to the platform structure and thereby bear against and lift a vehicle above the lifting structure, and advance downwardly and thereby lower relative to platform structure; and a power source and a remote control mechanism connected to the drive motor mechanism and to the steering power mechanism and to the lifting structure drive mechanism.

The lifting structure preferably includes a lifting plate and a lifting linkage assembly interconnecting the platform structure and the lifting plate so that movement of the lifting linkage assembly in a first direction elevates the lifting plate and lifts a vehicle above the lifting plate, and movement of the lifting linkage assembly in a second direction lowers the lifting plate and the vehicle.

The lifting linkage assembly preferably includes a guide track on the platform structure, a scissors jack with laterally crossing linkage members interconnected by a linkage center pin, the members having linkage lower ends slidably mounted in the linkage guide track so that the linkage lower ends in one track direction to elevate the lifting plate and are slidable in the other track direction to lower the lifting plate.

The lifting linkage drive mechanism preferably includes a linkage gear motor fastened to the platform structure and having a linkage gear motor drive shaft drivably connected to a drive screw and a linkage drive nut secured to one of the linkage lower ends so that operation of the linkage gear motor in one rotational direction elevates the lifting plate and in the other rotational direction lowers the lifting plate.

The linkage gear motor drive shaft preferably is connected to the drive screw with first and second linkage sprockets drivably joined by a linkage drive chain. The drive motor mechanism preferably includes a gear motor having a gear motor drive shaft drivably connected to the drive axle. The motor drive mechanism preferably is fitted with a first drive sprocket, and the drive axle is fitted with a second drive sprocket and the first and second drive sprockets are drivably interconnected by a drive train. The drive axle preferably is rotatably mounted within spaced apart and coaxially positioned flange mount bearings secured to the platform structure. The steering power mechanism includes a linear actuator connected to the platform structure and drivably connected to the steering linkage. The linear actuator preferably is connected to the platform structure with a first actuator connecting plate. The linear actuator preferably is drivably connected to the steering linkage with a second actuator connecting plate. The direction control wheels preferably are caster wheels pivotally connected to the platform structure and the steering linkage is connected to each of the direction control wheels. “The steering linkage preferably is connected to each of the direction control wheels through a ball joint.

The platform structure preferably includes a mechanism tray having a mechanism tray bottom wall the tray bottom wall including an upwardly extending outer perimeter wall and an upwardly extending inner perimeter wall. The power source preferably is at least one battery and the platform structure preferably additionally includes a battery tray preferably fastened to and protruding laterally from the mechanism tray for retaining the at least one battery. The tray bottom wall preferably is rectangular. The inner perimeter wall preferably includes four L-shaped inner perimeter wall segments defining inner walls of wheel wells for the drive wheels and the direction control wheels.

A vehicle lifting and maneuvering apparatus is provided, including a rolling platform structure; a drive wheel mounted to and downwardly protruding from the platform structure; a direction control wheel pivotally mounted to and downwardly protruding from the platform structure; a drive motor mechanism drivably connected to the drive wheel; a steering power mechanism operationally linked to the direction control wheels for turning the direction control wheel relative to the platform structure; a vehicle lifting structure and lifting structure drive mechanism secured relative to the platform structure and causing the lifting structure to one of: advance upwardly relative to the platform structure and thereby bear against and lift a vehicle above the lifting structure, and advance downwardly and thereby lower relative to the platform” structure; and a power source and a remote control mechanism connected to the drive motor mechanism and to the steering power mechanism and to the lifting structure drive mechanism.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of the preferred embodiment of the apparatus with the vehicle lifting structure retracted into its lowered position, with the lifting plate omitted.

FIG. 2 is a view substantially as in FIG. 1, showing the vehicle lifting structure extended to its elevated position.

FIG. 3 is a schematic top view of the apparatus showing the essential elements of the drive, steering and lifting means.

FIG. 4 is a view as in FIG. 3 showing only the platform structure structural elements.

FIG. 5 is a view as in FIG. 3 showing only the apparatus drive system.

FIG. 6 is a view as in FIG. 3 showing only the steering system.

FIG. 7 is a view as in FIG. 3 showing only the vehicle lifting system.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

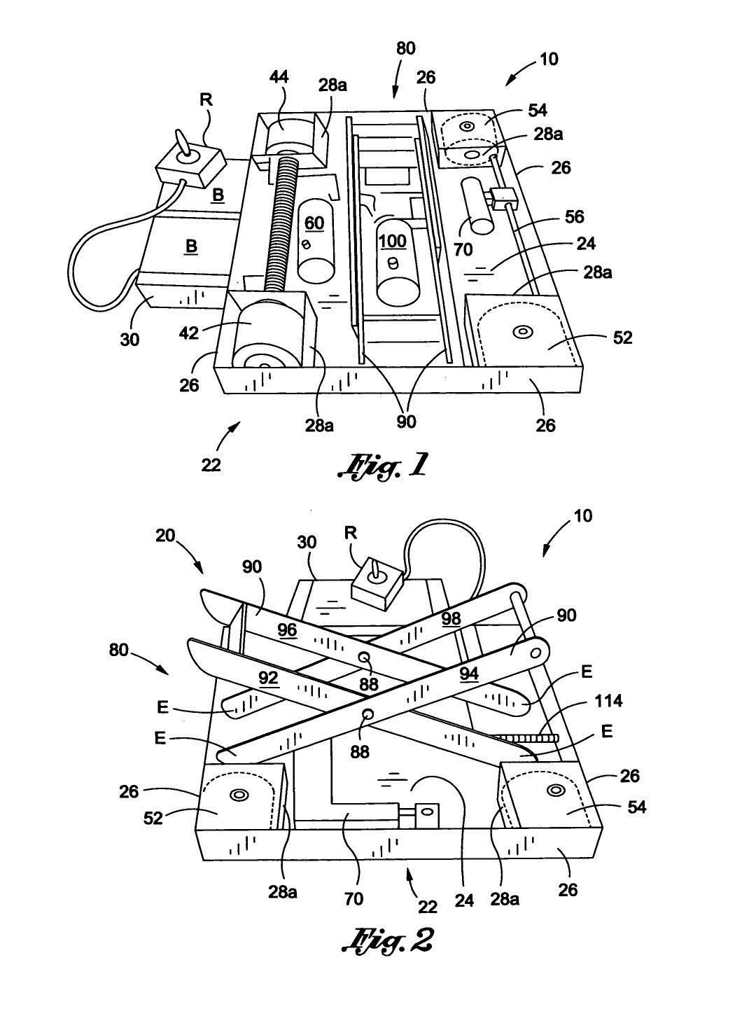

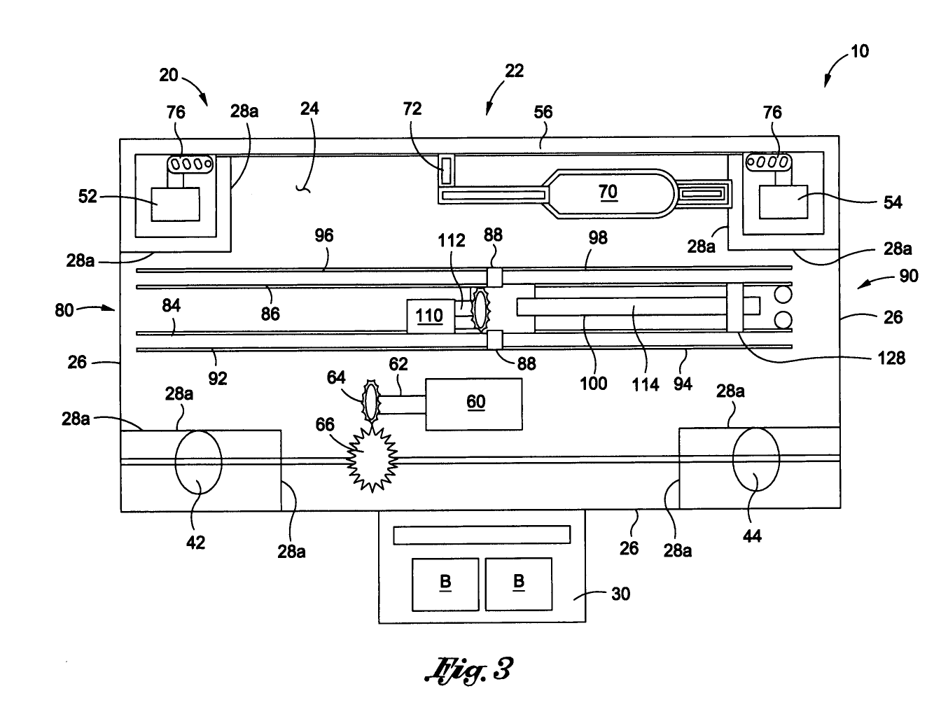

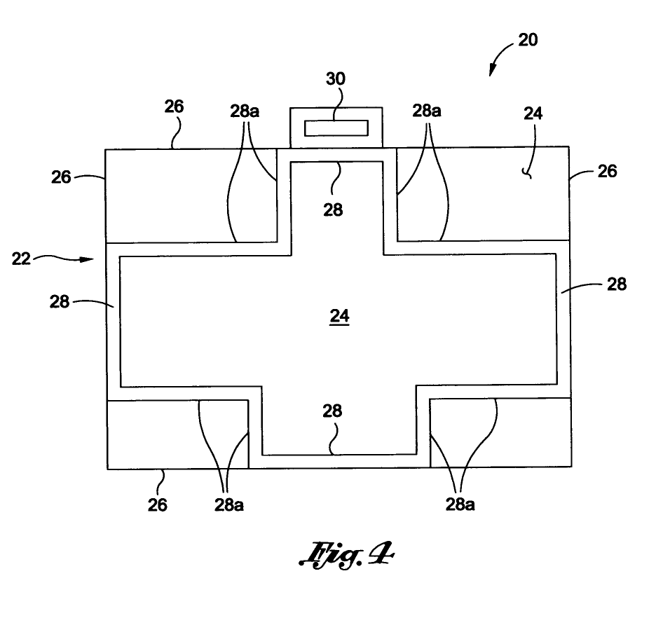

Referring to FIGS. 1-7, a vehicle lifting and maneuvering apparatus 10 is disclosed. Apparatus 10 includes a rolling platform structure 20 having two downwardly protruding drive wheels 42 and 44 interconnected by a drive axle 46 mounted to the platform structure 20 and two downwardly protruding direction control wheels 52 and 54 pivotally mounted to the platform structure 20 and interconnected by a steering linkage 56, a drive motor means 60 drivably connected to the drive axle 46, a steering power means 70 pivotally linked to the steering linkage 56 for moving the steering linkage 56 relative to the platform structure 20 and thereby turning the direction control wheels 52 and 54, vehicle lifting structure 80 and lifting structure drive means 100 causing the lifting structure 80 to one of: advance upwardly relative to the platform structure 20 and thereby bear against and lift a vehicle above the lifting structure 20, and advance downwardly and thereby lower the vehicle. A power source such as a platform mounted battery powers the drive motor means 60, steering power means 70 and lifting structure drive means 100, all of which are independently controlled by conventional remote control means R which includes a joy stick and toggle switch. The preferred example of the remote control means R is a hand switch for 3 actuators, model number 2236K17, by SNAP-ON™.

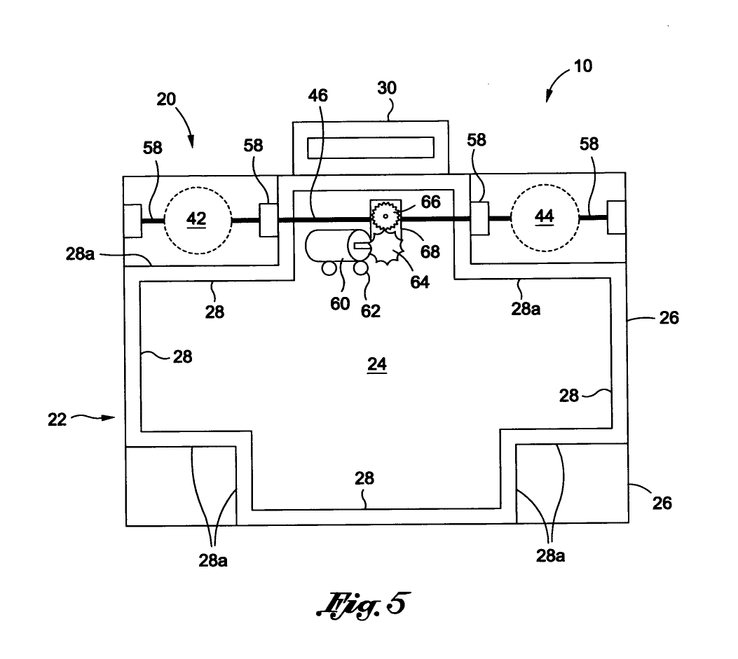

The platform structure 20 preferably includes a mechanism tray 22 having a mechanism tray bottom wall 24, which preferably is rectangular. See FIG. 4. The tray bottom wall 24 includes an upwardly extending outer perimeter wall 26 and an upwardly extending inner perimeter wall 28 having L-shaped inner perimeter wall segments 28a defining inner walls of wheel wells for the drive wheels 42 and 44 and the direction control wheels 52 and 54. A battery tray 30 preferably is fastened to and protrudes laterally from the mechanism tray 22 and securely retains the battery B.

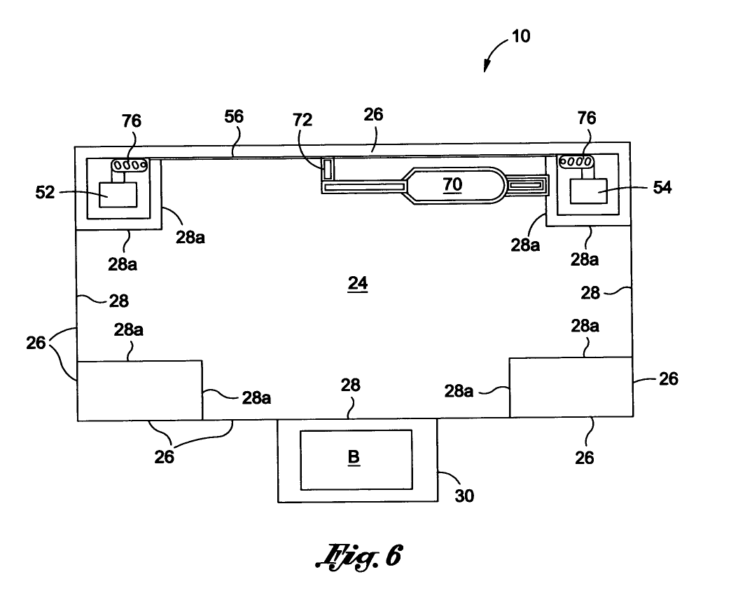

The drive motor means 60 preferably is a gear motor having a gear motor drive shaft 62 fitted with a first drive sprocket 64. See FIG. 5. A second drive sprocket 66 is fitted around the drive axle 46 and the first and second drive sprockets 64 and 66 are drivably interconnected by a drive chain 68. The drive axle 46 preferably is rotatably mounted within four spaced apart and coaxially positioned flange mount bearings 58 secured to the platform structure 20.

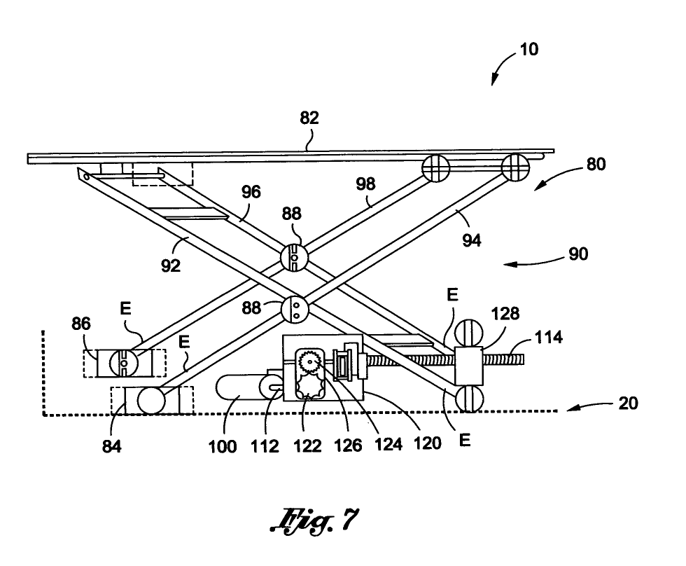

The steering power means 70 preferably is a linear actuator connected to the platform structure 20 with a first actuator connecting plate 72 and drivably connected to the steering linkage 56 with a second actuator connecting plate 74. See FIG. 6. The direction control wheels preferably are caster wheels pivotally connected to the platform structure 20 and the steering linkage 56 is connected to each of the direction control wheels 52 and 54 through a ball joint 76.

The lifting structure 20 preferably includes a lifting plate 82 and a lifting linkage assembly 90 interconnecting tile platform structure 20 and the lifting plate 82 so that movement of the lifting linkage assembly 90 in a first direction elevates the lifting plate 82 and lifts any vehicle positioned over the lifting plate 82, and movement of the lifting linkage assembly 90 in a second direction lowers the lifting plate 82 and the vehicle. See FIG. 7. The lifting linkage assembly 90 preferable takes the form of a scissors jack with laterally crossing linkage members 92, 94, 96 and 98 interconnected by a linkage center pin 88. The linkage lower ends E are slidably mounted in linkage guide tracks 84 and 86 so that the linkage lower ends E can be slid in one direction to elevate the lifting plate 82 and slid in the other direction along tracks 84 and 86 to lower the lifting plate 82. The lifting structure drive means 100 preferably includes a lifting gear motor 110 fastened to the platform structure 20 and having a linkage gear motor drive shaft 112 extending into a drive train box 120 and drivably connected to a drive screw 114 with first and second linkage sprockets 122 and 124, respectively, joined by a linkage drive chain 126. A linkage drive nut 128 is secured to one linkage lower end E so that operation of the lifting gear motor 110 in one rotational direction elevates the lifting plate 82 and in the other rotational direction lowers the lifting plate 82.

The power source is connected to four 12 volt dc power relays that transport power from low dc voltage coiled wires to higher dc voltage wires. Two relays operate the drive motor, one controls forward and the other controls reverse. The next two relays control the jack lifting system, one operating upward motion and the other operating downward motion. The low voltage wires are connected to a hand held control box that operate by a joy stick and a toggle switch, that signal the relays to send power to their command post. The linear actuator is powered with low voltage wires. The power source system is also protected by fuses. The powered relays and fuse pocket are bolted to an aluminum channel, which in turn is bolted to the front of the platform structure 20. The power source itself preferably includes two sealed lead-acid batteries running in parallel for a 44ah-12/vdc battery. A 12/vdc battery charger preferably is provided and is placed between the inner perimeter wall and the lifting plate 82 and bolted to the mechanism tray bottom wall.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A vehicle lifting and maneuvering apparatus comprising
a rolling platform structure including drive wheel means and a pair of directional control caster wheels connected to said platform structure and protruding downwardly from said platform structure and interconnected by a steering linkage,
a drive motor means mounted to the platform structure and drivably connected to said drive wheel means,
a steering control means linked to said steering linkage for turning said caster wheels relative to said platform structure,
a vehicle lifting structure and lifting structure drive means secured to said platform structure that moves the vehicle lifting structure in one direction to lift a vehicle above said lifting structure and moves vehicle lifting structure in an opposite direction to lower said vehicle lifting structure,
remote control means connected to said drive motor means and to said steering control mechanism and to said lifting structure drive means, such that said remote control means can be operated to remotely maneuver said vehicle lifting structure underneath a vehicle and to lift and lower the vehicle and to propel a lifted vehicle across a floor, and
a battery power source mounted to the platform structure that provides electrical power to operate the drive motor means, steering control means, and lifting structure drive means.

2. A vehicle lifting and maneuvering apparatus comprising
a rolling platform structure,
two drive wheels protruding downwardly from said platform structure and interconnected by a substantially horizontal drive axle mounted to said platform structure,
two direction control caster wheels pivotally connected to said platform structure and protruding downwardly from said platform structure and interconnected by a steering linkage connected to each of said caster wheels,
a drive motor means drivably connected to said drive axle,
a steering power means pivotally linked to said steering linkage for moving said steering linkage relative to said platform structure and thereby turning said caster wheels relative to said platform structure,
a vehicle lifting structure and lifting structure drive means secured to said platform structure and causing said lifting structure to one of: advance upwardly relative to said platform structure and thereby bear against and lift a vehicle above said lifting structure, and advance downwardly and thereby lower relative to said platform structure,
said lifting structure comprising a lifting plate and a lifting linkage assembly interconnecting said platform structure and said lifting plate such that movement of said lifting linkage assembly in a first direction elevates said lifting plate and lifts a vehicle above said lifting plate, and movement of said lifting linkage assembly in a second direction lowers said lifting plate and the vehicle,
said lifting linkage assembly comprising a guide track on said platform structure, a scissors jack with laterally crossing linkage members interconnected by a linkage center pin, said members having linkage lower ends slidably mounted in said linkage guide track such that said linkage lower ends are slidable in one track direction to elevate said lifting plate and are slidable in the other track direction to lower said lifting plate,
a battery power source mounted to the platform structure, and
remote control means connected to said drive motor means and to said steering power means and to said lifting structure drive means, such that said remote control means can be operated to remotely maneuver said vehicle lifting structure underneath a vehicle and to lift and lower the vehicle and to propel a lifted vehicle across a floor.

3. The apparatus of claim 2 wherein said steering linkage is connected to each of said direction control wheels through a ball joint.

4. The apparatus of claim 3 wherein said lifting linkage drive means comprises a linkage gear motor fastened to said platform structure and having a linkage gear motor drive shaft drivably connected to a drive screw and a linkage drive nut secured to one of said linkage lower ends such that operation of said linkage gear motor in one rotational direction elevates said lifting plate and in the other rotational direction lowers said lifting plate.

5. The apparatus of claim 4 wherein said linkage gear motor drive shaft is connected to said drive screw with first and second linkage sprockets drivably joined by a linkage drive chain.

6. The apparatus of claim 5 wherein said steering power means comprises a linear actuator connected to said platform structure and drivably connected to said steering linkage.

7. A vehicle lifting and maneuvering apparatus comprising
a rolling platform structure including drive wheel means, directional control wheel means and a steering linkage,
a drive motor means mounted to the platform structure and drivably connected to said drive wheel means,
a steering control means linked to said steering linkage for turning said directional control wheel means relative to said platform structure,
a vehicle lifting structure and lifting structure drive means secured to said platform structure,
remote control means connected to said drive motor means and to said steering control mechanism and to said lifting structure drive means, such that said remote control means can be operated to remotely maneuver said vehicle lifting structure underneath a vehicle and to lift and lower the vehicle and to propel a lifted vehicle across a floor, and
a battery power source mounted to the platform structure that provides electrical power to operate the drive motor means, steering control means, and lifting structure drive means,
said vehicle lifting structure including a lifting plate and a lifting linkage assembly interconnecting rolling platform structure and the lifting plate so that movement of the lifting linkage assembly in a first direction elevates the lifting plate and lifts any vehicle positioned over the lifting plate and movement of the lifting linkage assembly in a second direction lowers the lifting plate and the vehicle,
said lifting linkage assembly comprising a scissors jack with laterally crossing interconnected linkage members having lower ends that are slidably mounted in linkage guide track means on the rolling platform structure so that said lower ends slid in one direction along the guide track means to elevate the lifting plate and slid in another direction along said guide track means to lower the lifting plate.

8. The vehicle lifting and maneuvering apparatus of claim 7 wherein the drive means includes a lifting gear motor fastened to the platform structure and having a linkage gear motor drive drivably connected to a drive screw operably connected to at least one said lower end E so that operation of the lifting gear motor in one rotational direction elevates the lifting plate and in the other rotational direction lowers the lifting plate.

9. A vehicle lifting and maneuvering apparatus comprising
a rolling platform structure including drive wheel means, directional control wheel means and a steering linkage,
a drive motor means mounted to the platform structure and drivably connected to said drive wheel means,
a steering control means linked to said steering linkage for turning said directional control wheel means relative to said platform structure,
a vehicle lifting structure and lifting structure drive means secured to said platform structure,
remote control means connected to said drive motor means and to said steering control mechanism and to said lifting structure drive means, such that said remote control means can be operated to remotely maneuver said vehicle lifting structure underneath a vehicle and to lift and lower the vehicle and to propel a lifted vehicle across a floor, and
a battery power source mounted to the platform structure that provides electrical power to operate the drive motor means, steering control means, and lifting structure drive means,
said vehicle lifting structure including a lifting plate and a lifting linkage assembly interconnecting rolling platform structure and the lifting plate so that movement of the lifting linkage assembly in a first direction elevates the lifting plate and lifts any vehicle positioned over the lifting plate and movement of the lifting linkage assembly in a second direction lowers the lifting plate and the vehicle, and
lifting structure drive means including a lifting gear motor fastened to the rolling platform structure and having a linkage gear motor drive shaft extending into a drive train box and drivably connected to a drive screw.
